(19) United States
(12) Patent Application Publication
(10) Pub. No.: US 2015/0066541 A1
(43) Pub. Date: Mar. 5, 2015

(54) CREATION AND MANAGEMENT OF ASSET GUARANTEE BONDS

(71) Applicants: Joseph Arnall, Jacksonville Beach, FL (US); Frank Arnall, III, Orlando, FL (US)

(72) Inventors: Joseph Arnall, Jacksonville Beach, FL (US); Frank Arnall, III, Orlando, FL (US)

(21) Appl. No.: 14/016,967

(22) Filed: Sep. 3, 2013

(51) Int. Cl. G06Q 40/08

(52) U.S. Cl. CPC G06Q 40/08
USPC 705/4

(57) ABSTRACT

Systems, methods, and computer program products which facilitate the creation and/or management of bonds with self-extinguishing elements are disclosed. In an aspect, a bond may be issued by a surety company on behalf of a principal and backed by the issuance of life insurance policies on the members of the principal. The principal may pay a bond premium comprising life insurance premiums and a management premium to the surety in lieu of paying a traditional coupon to the holders of the bond. Death benefit proceeds are payable to the surety or other managing entity who is responsible for paying the bond holders according to the terms of the bond. Upon the maturing of the bond, the asset may be sold and a predetermined amount may be given to the bond holders as principal.

### FIELD OF THE DISCLOSURE

The present disclosure generally relates to financial instrument creation and management and more particularly to systems, methods and computer program products for facilitating the creation and management of bonds.

### BACKGROUND

The statements in this section merely provide background information related to the present disclosure and may not constitute prior art.

Many municipalities, businesses, and other entities face a common, far reaching problem: unfunded long term obligations. That is, many of these entities committed to providing a pension for individuals who devoted a substantial period of their working life to the entity. These entities further planned to deposit (or fund) monies into a pension fund in order to fulfill their obligations to their pensioners. In virtually all cases, monies were deposited for a time, creating a large pool of funds. Despite this long-standing commitment, politicians, managers, stockholders, and other authorities have raided such large, attractive pools of funds for more immediate funding needs.

Such large pools of funds are typically invested in Treasury bills, mutual funds and the stock market. More problematically, those funds are also invested in high-risk investments, such as credit default swaps, high-yield bonds, and collateralized debt obligations. Even in circumstances where pension fund managers did not raid such funds or divert deposits to other projects, economic downturns, such as the Great Recession, have significantly reduced the value of pension funds. Many pension funds are worth significantly less than necessary to cover their associated pension obligations, creating an unfunded long-term liability. Such shortfalls are often measured in the billions of dollars.

Pension shortfalls and shortfalls in funding other long-term obligations have traditionally been addressed in three ways: raising taxes, “doubling down” on high-risk, high-yield investments, and issuing bonds.

First, raising taxes is a politically precarious option available only to certain government entities. In virtually any political climate, raising taxes, especially ad valorem or sales taxes, is extremely difficult, if not impossible. The mere mention of such a path can be very damaging to a politician's career and reelection prospects.

Second, doubling down on high-risk, high-yield investments in order to rebuild or boost the value of a pension fund or other funding source of a long-term obligation is an extremely precarious proposition for at least two reasons: (1) due to previous losses, the fund has fewer resources to invest, thereby limiting the potential upside of any investment; and (2) continued dedication to investments which have failed to produce significant returns is ill-advised and politically dangerous.

Third, issuing a traditional bond to raise money to pay for a long-term obligation or large capital project has traditionally been a relatively straightforward avenue. Such bonds are typically general obligations of the issuer. The interest rate, or coupon, on such bonds is heavily influenced by the credit rating of the issuing entity. In recent years, municipalities, state and federal entities, private enterprises, and even the United States itself have seen their credit ratings downgraded, driving the cost of raising money via bonds up and the total available pool of money down. In sum, poor credit ratings reduce the utility of a bond to public or private entities.

Municipal bonds may be secured by specified revenues, such as tax revenue. Securing a bond in this manner may allow a municipality to secure a better interest rate compared to a general obligation bond based solely on the credit rating of the municipality. On the other hand, such a bond may be politically difficult to create (e.g., where the bond is based on increasing the local sales tax by 1%). Additionally, revenues that fund bond repayments may fall if the citizenry moves away or changes their behavior to avoid the revenue generating activity (e.g., avoiding toll roads).

Additionally, new Government Accounting Standards Board (GASB) rules—subject to oversight from the Financial Accounting Foundation—not only require unified disclosure of all state and local government liabilities, but also require realistic projections of future pension liabilities and an accelerated plan to fully fund the liabilities using a current interest rate. Furthermore, the public is entitled to a full disclosure of the relative risk before buying any municipal bond from mid-2013, onward. Such rules further limit the utility of current bond structures and current methods of addressing unfunded long term liabilities.

Given the foregoing, systems, methods, and computer program products are needed that facilitate creation and management of financial instruments which reduce long-term funding obligations, such as pension fund shortfalls. Such systems, methods, and computer program products should not depend on the credit rating of the issuing entity. Such systems, methods, and computer program products should be tied to one or more assets. Such assets may include, but should not be limited to: tangible assets; intangible assets; and contracts.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure provide systems, methods, and computer program products which facilitate the creation and/or management of bonds with self-extinguishing elements. Such bonds may be issued by a surety company on behalf of a principal and backed by the issuance of life insurance policies on the members of the principal.

In an aspect, bonds created, issued, and managed in accordance with the present disclosure may enable governments to make a capital contribution of the discounted future value of the pledged assets to an unfunded liability, such as a pension plan, in lieu of cash, thereby reducing or eliminating the unfunded liability. Such a reduction or elimination of unfunded liability may enable the rating agencies to issue a better rating on any future bond. Such better ratings will result in lower interest costs as they indicate less risk for the investor.

Among the assets that may be utilized to back such bonds, life insurance policies on a large group of individuals (e.g., unionized government workers for a city) are well placed to facilitate repayment of bonds because it is paid out over many years for a large group of people. Because bonds terms are typically measured in decades, the rate of return profile may be similar.

In an aspect, systems, methods, and computer program products in accordance with the present disclosure facilitate the creation of bonds which may be issued by municipalities with extremely poor credit ratings, and municipalities that are insolvent or near insolvency, especially in light of the new GASB accounting standards. Such government entities are otherwise unbondable, however the present disclosure provides a mechanism wherein a third-party surety company may issue a bond on behalf of the municipality, facilitating a reduction in unfunded liabilities.

In an aspect, bonds according to the present disclosure are annually renewable and guarantee the net present value of an asset at a fixed future time. An asset will be assigned or otherwise pledged as collateral security and a condition for the surety to issue the bond. Because the asset accepted as security may increase in value over the term of the bond, the actual value may exceed the projected value sooner than the original stated term of the bond so that the principal may elect to unilaterally terminate the bond and the surety will release the assets.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating the creation and management of an asset guarantee bond, according to an aspect of the present disclosure.

FIG. 2 is a data flow diagram of an exemplary process for facilitating the creation and management of an asset guarantee bond, wherein the asset is a plurality of life insurance policies, according to an aspect of the present disclosure.

FIG. 3 is a flowchart illustrating an exemplary process for determining the value, determining the issuing criteria, and issuing an asset guarantee bond, according to an aspect of the present disclosure.

FIG. 4 is a flowchart illustrating an exemplary process for facilitating the reduction of unfunded liabilities via the creation of an asset guarantee bond, according to an aspect of the present disclosure.

FIG. 5 is a flowchart illustrating an exemplary process for facilitating management of an asset guarantee bond, according to an aspect of the present disclosure.

FIG. 6 is a block diagram of an example computing system useful for implementing the present disclosure.

### DETAILED DESCRIPTION

The present disclosure is directed to systems, methods, and computer program products for facilitating the creation and management of financial instruments (e.g., a bond) backed by one or more assets having a net present value (e.g., life insurance policies).

Aspects of the present disclosure provide systems, methods, and computer program products which facilitate the creation and/or management of bonds with self-extinguishing elements. Such bonds may be issued by a surety company on behalf of a principal and backed by the issuance of life insurance policies on the members of the principal. The principal may pay a bond premium comprising life insurance premiums and a management premium to the surety or other managing entity (e.g., an agent, surety company, and the like) in lieu of, or in addition to, paying a coupon to the holders of the bond. Death benefit proceeds are payable to the surety or other managing entity who is responsible for paying the bond holders according to the terms of the bond. Upon the maturing of the bond, the asset may be sold and a predetermined amount may be given to the bond holders as principal.

In another aspect, the principal may pay the life insurance premium to the life insurance company or companies as directed by the managing entity. The principal may also pay the managing entity a management fee.

In another aspect, such bonds may be issued by the principal directly to the bond holders. Such a bond may be underwritten by the surety or otherwise backed or managed by the surety, managing entity, or other party or parties as apparent to those skilled in the relevant art(s) after reading the description herein.

In an aspect, the assets accepted as security (e.g., life insurance policies on the principal's employees, retirees or other individuals associated with the principal) are initially valued at a net present value at a fixed future date (e.g., 20 years in the future). Because the asset accepted as security may increase in value over the term of the bond, the actual value may exceed the projected net present value on the maturity date prior to the original stated term of the bond. The principal may elect to terminate the bond. The surety may then release their ownership interest in the assets, giving the principal ownership of the assets after compensating the bond holders in accordance with the bond terms.

In an aspect, asset guarantee bonds created, issued and managed in accordance with the present disclosure may be issued by the surety, rather than a public entity, and are configured to guarantee the future value of pledged assets at an agreed upon future date. This also enables the current net present value of pledged assets to be guaranteed by the surety and thereby suitable for contribution to a municipal pension to reduce unfunded liability under present GASB rules.

An asset guarantee bond may be privately placed and the value and conditions are set by the surety, thereby having little or nothing to do with a public rating agency, the credit rating of the principal (e.g., a distressed municipality), nor traditional bond brokers. The principal does not pay interest, rather a fee to the surety plus the cost of maintaining of the asset (i.e., the collateral). No later than the end of the bond term, the surety pays the obligee (e.g., a municipal pension, the principal, and the like) the bond amount and releases any remaining ownership interest in the assets. Where the assets are life insurance policies issued on the lives of a large pool of municipal workers, the beneficiary may be reassigned from the surety to the principal, a specific department or funding obligation, or the insured individuals themselves, some other individual or entity apparent to those having reasonable skill in the relevant arts after reading the description herein. Therefore, bonds in accordance with the present disclosure have a self-redeeming or liquidating feature.

Such bonds are may be useful in the significant reduction or even elimination of unfunded pension liability for private and public entities alike. This reduction in unfunded liabilities should enable a municipality, for example, to obtain a higher credit rating and thus pay less interest for bonds that may be needed in the future for other public purposes.

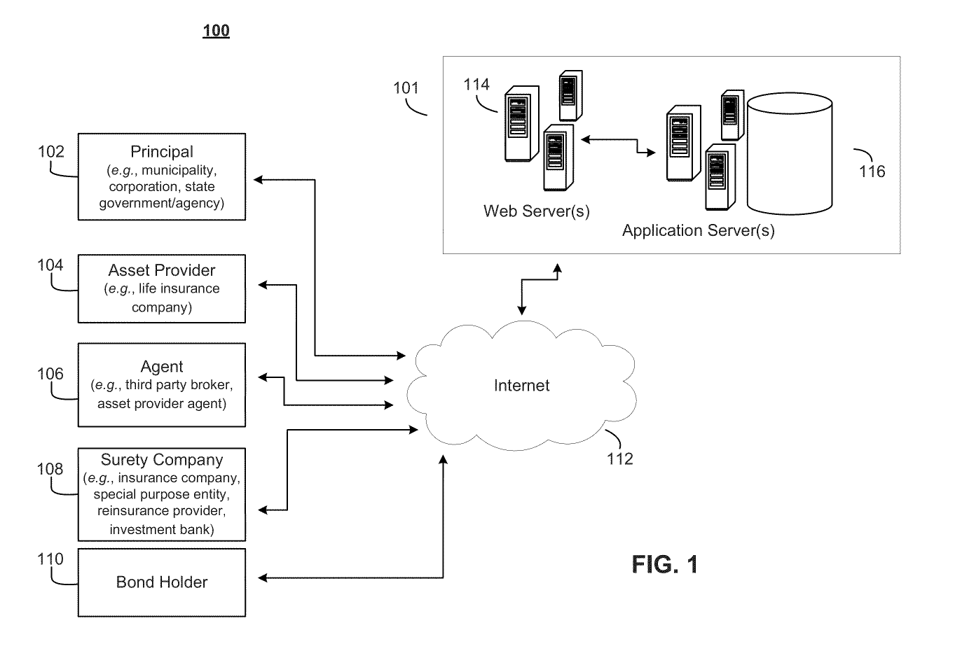

Referring now to FIG. 1, a block diagram of an exemplary system for facilitating the creation and management of an asset guarantee bond, according to an aspect of the present disclosure, is shown.

Cloud-based, Internet-enabled communication system 100 may include one or more principals 102, asset providers 104, agents 106, sureties 108, and bond holders 110 accessing—via a computing device and a network 108, such as the global, public Internet—an application service provider's cloud-based, Internet-enabled infrastructure 101. One or more of principal 102 or representatives, employees, or retirees of principal 102, asset provider 104, agent 106, surety 108 and bond holder 110 may access infrastructure 101 in order to facilitate the creation, issuing, and management of financial instruments in accordance with the present disclosure.

As shown in FIG. 1, in an aspect of the present disclosure, an application service provider's cloud-based, communications infrastructure 101 may include one or more web servers 114 and one or more application servers 116.

As will be appreciated by those skilled in the relevant art(s) after reading the description herein, in such an aspect, an application service provider—an individual person, business, or other entity—may allow access, on a free registration, paid subscriber and/or pay-per-use basis, to infrastructure 101 via one or more World-Wide Web (WWW) sites on the Internet 112. Thus, system 100 is scalable.

As will also be appreciated by those skilled in the relevant art(s), in an aspect, various screens would be generated by web server 114 in response to input from users 102 over Internet 112. That is, in such an aspect, server 114 is a typical web server running a server application at a website which sends out webpages, while in communications with server 116, in response to Hypertext Transfer Protocol (HTTP) or Hypertext Transfer Protocol Secured (HTTPS) requests from remote browsers on computing devices being used by various principals 102, representatives of principals 102, employees of such principals 102, retirees of such principals 102, asset providers 104, agents 106, sureties 108 and bond holders 110. Thus, server 114 is able to provide a graphical user interface (GUI) in the form of webpages. These webpages are sent to the associated computing devices, and would result in the GUI being displayed.

In alternate aspects, application servers 116 (shown with associated storage in FIG. 1) may be configured to store various modules and data associated with bond terms, bond premiums, assets, registration and demographic information associated with one or more of principal 102, employees of principal 102, retirees of principal 102, asset provider 104, agent 106, surety 108 and bond holder 110, payment information, management information, and the like. In alternate aspects, application servers 116 may comprise one or more data stores within (or remotely located from) infrastructure 101 or be a memory included in (or coupled to) web server(s) 110. That is, in alternate aspects, web servers 110 and application servers 116 may be located on the same physical machines as will be appreciated by those skilled in the relevant art(s) after reading the description herein.

As will be appreciated by those skilled in the relevant art(s) after reading the description herein, alternate aspects of the present disclosure may include providing a tool for facilitating the creation and management of financial instruments (e.g., a bond) backed by one or more assets having a net present value (e.g., life insurance policies) as a stand-alone system (e.g., installed on one server PC) or as an enterprise system wherein all the components of infrastructure 100 are connected and communicate via an inter-corporate Wide Area Network (WAN) or Local Area Network (LAN). For example, in an aspect where one or more of principal 102, employees, representatives, or retirees of principal 102, asset provider 104, agent 106, surety 108 and bond holder 110 are all customers of the same entity (or affiliated entities), the present disclosure may be implemented as a stand-alone system, rather than as a web service (e.g., Application Service Provider (ASP) model utilized by various unassociated/unaffiliated users and merchants) as shown in FIG. 1.

As will also be appreciated by those skilled in the relevant art(s) after reading the description herein, alternate aspects of the present disclosure may include providing the tools for facilitating the creation and management of financial instruments backed by one or more assets having a net present value, a browser pre-installed with an applet or a browser with a separately downloaded applet on a computing device. That is, as will also be apparent to one skilled in the relevant art(s) after reading the description herein, an applet that facilitates the asset guarantee bond of the present disclosure disclosed herein may be part of the “standard” browser that ships with a computing device or may be later added to an existing browser as part of an “add-on,” or “plug-in,” or may be added as a separate mobile application software (app) capable of executing on a computing device after an “app store download.”

In one aspect, system 100 and its accompanying methods and computer program products of the present disclosure is configured to facilitate the creation, issuing, and management of an asset guarantee bond wherein the asset is a plurality of life insurance policies issued on the lives of principal 102 employees between the ages of 45 and 55, the benefit of which flows to surety 108 until the bond matures or is extinguished. Thus, the present disclosure is now described in more detail herein in terms of the above exemplary context. This is for convenience only and is not intended to limit the application of the present disclosure. In fact, after reading the following description, it will be apparent to one skilled in the relevant art(s) how to implement the following disclosure in alternative embodiments (e.g., any context where a bond is created which is backed by an asset such as life insurance policies for a substantial number of individuals associated with the bond issuer or principal 102).

Unless otherwise noted, for the purposes of the present disclosure, “principal” and/or the plural form of these terms are used interchangeably throughout to refer to the entity that authorizes or requests the bond issuance. The principal may be the entity which oversees or controls an unfunded or undercapitalized obligation, such as a construction project, a maintenance project, a pension fund, a long-term research and development plan, a long-term public works project, a large-scale project, and the like. In an aspect, the principal receives the remaining ownership interest in the asset when the related bond has been fulfilled. The principal may be a municipality, a state agency, a county, a city, a town or township, a parish, a state, a corporate entity, a division of a corporate entity, a union, a federal agency, a country, and the like. The principal may have a significant number of employees and/or retirees. For example, a municipality may have hundreds or thousands of public employees such as firefighters, police, teachers, administrators, maintenance crews, and the like, as well as individuals who retired from such positions.

Unless otherwise noted, for the purposes of the present disclosure, “surety” and/or the plural form of these terms are used interchangeably throughout to refer to an entity which issues bonds in accordance with the present disclosure. The surety may also manage such bonds. The surety may be an insurance company, a reinsurance company, a special purpose entity, an investment bank, and the like.

In an aspect, the principal may also serve as the surety.

Unless otherwise noted, for the purposes of the present disclosure, “asset” and/or the plural form of these terms are used interchangeably throughout to refer to tangible property, intangible property, contracts, or other value which may be pledged as collateral for issuing and/or maintaining financial instruments in accordance with the present disclosure. An asset may be life insurance policies issued on the lives of a large number of the principal's employees. Where life insurance has been issued on the lives of, for example, 1,000 within a certain age and health range, actuarial methods indicate that a net present value may be assigned to the policies, based in part on mortality rates of such individuals. Because life insurance policies may be purchased, an asset is created which is suitable for use with systems, methods, and computer program products in accordance with the present disclosure.

An asset may also be real property, an intellectual property right or portfolio, mineral rights, licenses, leases, and the like. In an aspect, such assets may be pledged via a life insurance contract, a bailment agreement, an intellectual property rights assignment, a property management agreement, and the like.

Unless otherwise noted, for the purposes of the present disclosure, “agent” and/or the plural form of these terms are used interchangeably throughout to refer to individuals and entities which broker, sell, or otherwise manage or assist in the creation, issuance, and management of asset guarantee bonds in accordance with the present disclosure. An agent may be a third-party broker, an asset provided agent, a life insurance agent, or the like. In an aspect, the agent and the surety are the same entity. In another aspect, the agent, surety, and principal are the same entity.

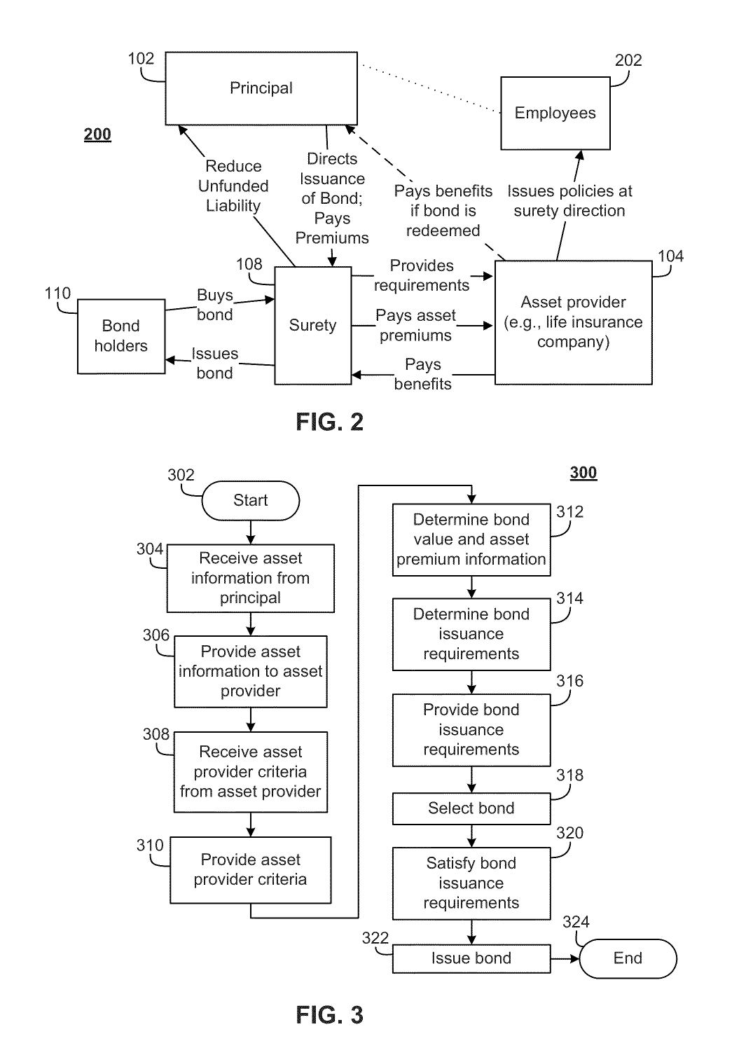

Referring now to FIG. 2, a data flow diagram 200 for facilitating the creation and management of an asset guarantee bond, wherein the asset is a plurality of life insurance policies, according to an aspect of the present disclosure, is shown.

Portions of data flow diagram may reside system 100.

In order to reduce its unfunded liabilities, principal 102 may engage surety 108 to issue an asset guarantee bond in accordance with the present disclosure. That is, principal 102 directs the issuance of a bond. The current net present value of the pledged assets may be guaranteed by surety 108 and therefore used to reduce the unfunded liability in an amount based on the net present value of the pledged assets.

In another aspect, principal 102 may issue asset guarantee bond directly to bond holders 110.

In an aspect, principal 102 has a large number of employees 202. An asset is created in collaboration with surety 108 and asset provider 104 comprising life insurance policies on a number of employees 202. In an aspect, principal 102 must secure the consent of employee 202 in order to secure a life insurance policy based on their life. In order to entice employee 202 to consent, principal 102 may elect to provide an additional policy naming as beneficiary an individual employee 202 designates. Each life insurance policy pays benefits to surety 108 during the life of the bond. If the bond is redeemed, surety 108 may release its interest in the life insurance benefits, allowing the benefits to be paid to principal 102. In an aspect, such benefits are paid into a fund to further reduce the original unfunded/undercapitalized liability. In another aspect, the life insurance policies are sold for their net present value and the proceeds are collected by principal 102 for general use. In another aspect, benefits may be paid to employees 202.

In order to maintain the asset, principal 102 may pay surety 108 a premium. Such premiums comprise a management fee and a life insurance premium. Surety 108 pays asset premiums, such as life insurance premiums, to asset provider 104 in order to maintain the value of the pledged assets. Pre-issuance of the bond, surety 108 and principal 102 may provide their requirements to asset provider 108. Such requirements may include, but are not limited to, the types of life insurance policies to issue, the number of polices to issue, the types of persons to be insured, and the like. Where the pledged asset is not life insurance-based requirements may include, but are not limited to, maintenance costs, government fees, and the like.

In an aspect, principal 102 may directly pay asset provider 104 premiums associated with maintaining one or more assets (e.g., life insurance policies). Principal 102 may additionally pay surety 108 a management fee or other compensation. In another aspect, principal 102 may provide surety 108 with separate payments related to asset premiums and management fees.

Asset provider 104 may issue life insurance policies at the direction of surety 108 or principal. In an aspect, employees 202 must sign off on the issuance of a life insurance policy on their life appointing surety 108 or principal 108 the beneficiary.

Surety 108 issues a bond which is purchased by bond holders 110. Bond holders 110 are thereby entitled to benefits according to the bond terms. A related unfunded liability (e.g., a pension plan) may be an obligee of the bond, as directed by principal 102.

As will be apparent to one skilled in the relevant art(s) after reading the description herein, entities may assume multiple roles in implementing the present disclosure without departing from its scope. For example, principal 102 may also serve as surety, thereby reducing overhead costs. Surety 108 may also be asset provider 104, issuing life insurance policies to be pledged as collateral for the bond. Agent 106 may manage all or part of system 200. Agent 200 may also form relationships with entities within system 200, thereby facilitating the operations.

In an aspect, principal 102 is a municipality, such as the City of Jacksonville. Municipality 102 wishes to utilize an asset guarantee bond in accordance with FIG. 2 wherein the asset is life insurance policies taken out on municipality employees 202. Municipality 102 will use such a bond to immediately reduce its unfunded liability for its employee pension fund. Asset provider 104 is a large insurance company and surety 108 is a private, for-profit entity. Bond holders 110 are members of the public. Municipality 102 pays a recurring premium to surety 108 which in turn pays life insurance premiums on employee life insurance plans to insurance company 104. Table A provides exemplary financials and asset metrics.

TABLE A

| | |
|---|---|
| Number of Employees | 1,000 |
| Death benefit per Employee | $350,000 |
| Annual Life Insurance Premium | $3,912,000 |
| Annual premium paid by municipality | $250,000 |
| to surety | |
| Net Present Value contributed to | $210,000,000* |
| unfunded pension fund | |
| Misc info | *Assuming a 40% discount |
| | required by surety 108 |
| | underwriters (may vary). |

Referring now to FIG. 3, a flowchart illustrating an exemplary process 300 for determining the value, determining the issuing criteria, and issuing an asset guarantee bond, according to an aspect of the present disclosure, is shown.

Process 300, which may execute within system 100, begins at step 302 with control passing immediately to step 304.

At step 304, infrastructure 101 receives asset information from principal 102. Principal 102 may supply demographic information about individuals associated with principal, such as employees, contractors, retirees and the like. In another aspect, principal 102 may supply information about real estate-based assets, such as rental properties. Asset information may include rental rates, percent occupancy, lease terms, property values, property locations, and the like.

In an aspect, agent 106 or a third party may collect the asset information and provide it to infrastructure 101.

At step 306, the asset information received in step 304 is provided to asset provider 104. Asset provider 104 may analyze such data and generate asset provider criteria for providing (in the case of life insurance) an asset or maintaining (in the case of real estate) the asset. Asset provider 104 may perform this analysis within infrastructure 101, or on asset provider 104 operated computing devices.

In an aspect, asset information is received by asset provider 104 servers and processed according to algorithms asset provider 104 has developed with determine underwriting criteria for the provided assets such as age, demographic information, history of illness, residential address, occupation, amount of coverage desired, insurance premium, and the like.

In an aspect, asset information is analyzed within infrastructure 101 by algorithms provided, updated, and/or maintained by asset provider 104.

At step 308, the asset provider criteria developed in step 308 is received by infrastructure 101. Asset provider criteria may be received via web server 114 or received via a connected computing device.

In an aspect, step 308 is omitted due to the internal generation of the asset provider criteria.

At step 310, asset provider criteria generated at step 306 is provided. In an aspect, such asset provider criteria are provided to surety 108 for evaluation. Presentation may be performed by surety 108 accessing infrastructure 101. In another aspect, asset provider criteria is sent to surety 108 via Internet 112. Asset provider criteria may also be presented to principal 102, agent 106, or another party.

At step 312, the bond value is determined. In an aspect surety 108 utilizes actuarial tables to determine the current net present value of the assets and the net present value at the date of maturity. Surety 108 may also determine the asset premium information based on the premiums, maintenance fees, or operating expenses required by asset provider 104. In this manner, surety 108 may determine how much must be collected from principal 102 and at what rate and how much may be contributed to a long term unfunded liability of principal 102.

At step 314, surety 108 determines the bond issuance requirements. Bond issuance requirements may include, but are not limited to: the amount of life insurance that must be issued per individual participant in the asset; the percentage of individuals suitable for insurance which must comply in order to achieve a certain bond value (generally, the value sought by principal 102); the total value of insurance policies to be issued; and the like.

At step 316, the bond issuance requirements are presented to principal 102, principal's agents, or another party which may facilitate decision making.

At step 318, principal 102 selects the bond they wish to have issued on their behalf.

At step 320, principal 102 satisfies the bond issuance requirements. As shown in step 322, in an aspect, the bond issuance requirements must be met prior to issuance of the bond. In another aspect, some criteria may be left unsatisfied for a short period of time after the bond has issued. For example, principal 102 may secure life insurance policies over a period of time before and after issuance of the bond, thereby enabling a larger pool of assets.

At step 322, the bond is issued.

Process 300 then terminates at step 324.

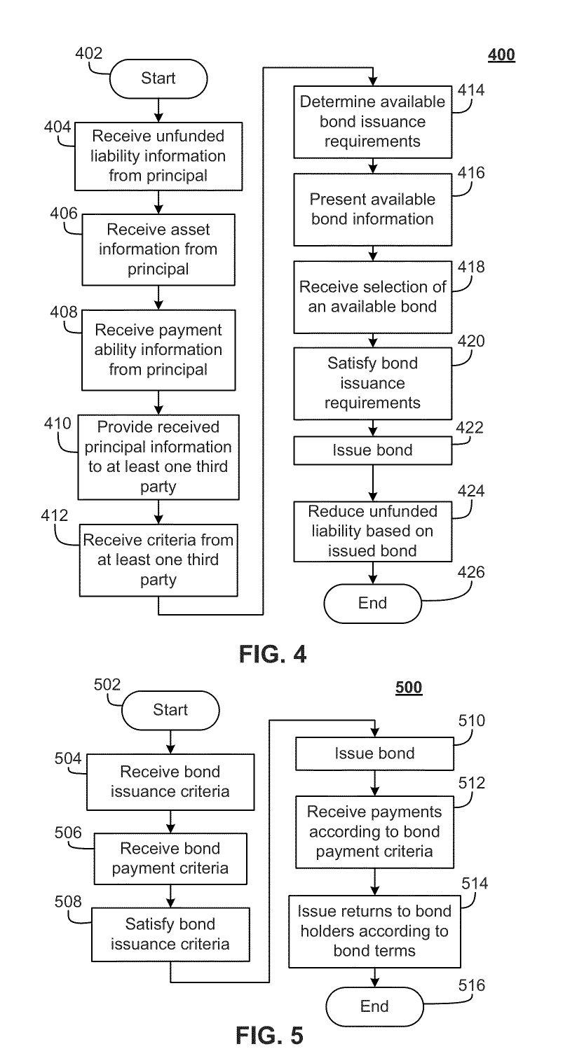

Referring now to FIG. 4, a flowchart illustrating an exemplary process 400 for facilitating the reduction of unfunded liabilities via the creation of an asset guarantee bond, according to an aspect of the present disclosure, is shown.

Process 400, which may execute within system 100, begins at step 402 with control passing immediately to step 404.

At step 404, infrastructure 101 receives unfunded liability information from principal 102. In another aspect, the unfunded liability information is received from agent 106 or a third party. Unfunded liability may include, but is not limited to: current funding for a long term liability, such as a pension fund; funding shortfalls; dates additional funds will be needed; when current funding will no longer meet outlay obligations; and the like.

At step 406, infrastructure 101 receives asset information from principal 102. Principal 102 may supply demographic information about individuals associated with principal, such as employees, contractors, retirees and the like. In another aspect, principal 102 may supply information about real estate-based assets, such as rental properties. Asset information may include rental rates, percent occupancy, lease terms, property values, property locations, and the like.

In an aspect, agent 106 or a third party may collect the asset information and provide it to infrastructure 101.

At step 408, principal 102 or a third party supplies the ability of principal 102 to make recurring payments. Collection of such information enables a determination of bond value based in part on the premium principal 102 can afford to maintain.

At step 410, information collected in steps 408, 406, and 404 are provided to at least one third party, including computer systems or software modules of a third party. The third party may such data and provide, for example, asset provider criteria for providing (in the case of life insurance) an asset or maintaining (in the case of real estate) the asset. Asset provider 104 may perform this analysis within infrastructure 101, or on asset provider 104 operated computing devices.

At step 412, the asset provider criteria developed in step 410 is received by infrastructure 101. Asset provider criteria may be received via web server 114 or received via a connected computing device.

In an aspect, step 412 is omitted due to the internal generation of the asset provider criteria.

At step 414, bond values and issuance requirements for one or more bonds backed by assets of principal 102 are determined.

At step 416, bond information determined in step 414 is presented to principal, agent 106, or a third party for evaluation.

At step 418, a bond selection is received, indicating the bond which will be issued on behalf of principal 102.

At step 420, principal 102 satisfies the bond issuance requirements. In an aspect, the bond issuance requirements must be met prior to issuance of the bond. In another aspect, some criteria may be left unsatisfied for a short period of time after the bond has issued.

At step 322, the bond is issued.

At step 324, surety 108 makes a contribution which reduces a specified liability of principal 102.

Process 400 then terminates at step 426.

Referring now to FIG. 5, a flowchart illustrating an exemplary process 500 for facilitating management of an asset guarantee bond, according to an aspect of the present disclosure, is shown.

Process 500, which may execute within system 100, begins at step 502 with control passing immediately to step 504.

At step 504, infrastructure 101 receives bond issuance criteria from one or more of: surety 108, agent 106, and asset provider 104. In an aspect, this step is replaced by the generation of bond issuance criteria by one or more modules within infrastructure 101, the modules being programmed to produce bond issuance criteria based on inputs provided by principal 102, asset provider 104, surety 108, and the like.

At step 506, bond payment criteria are received. Bond payment criteria may be both an initial payment and a recurring payment payable by principal 102 in order to maintain the bond. In an aspect, this step is replaced by the generation of bond payment criteria by one or more modules within infrastructure 101, the modules being programmed to produce bond payment criteria based on inputs provided by principal 102, asset provider 104, surety 108, and the like.

At step 508, bond issuance criteria are satisfied. In similar fashion to processes 300 and 400, this step may be entirely performed before executing step 510, issuing the bond. Step 508 may also be partially performed before executing step 510, or executed after executing step 510.

At step 512, payments are received by surety 108 in accordance to bond payment criteria. In turn, surety 508 may pay asset provider 106 an asset premium in order to maintain the pledged assets.

At step 514, returns such, as a coupon rate, are issued to bond holders 110 according to the bond terms. In an aspect, such returns may be calculated and/or processed by infrastructure 101.

Process 500 then terminates at step 516.

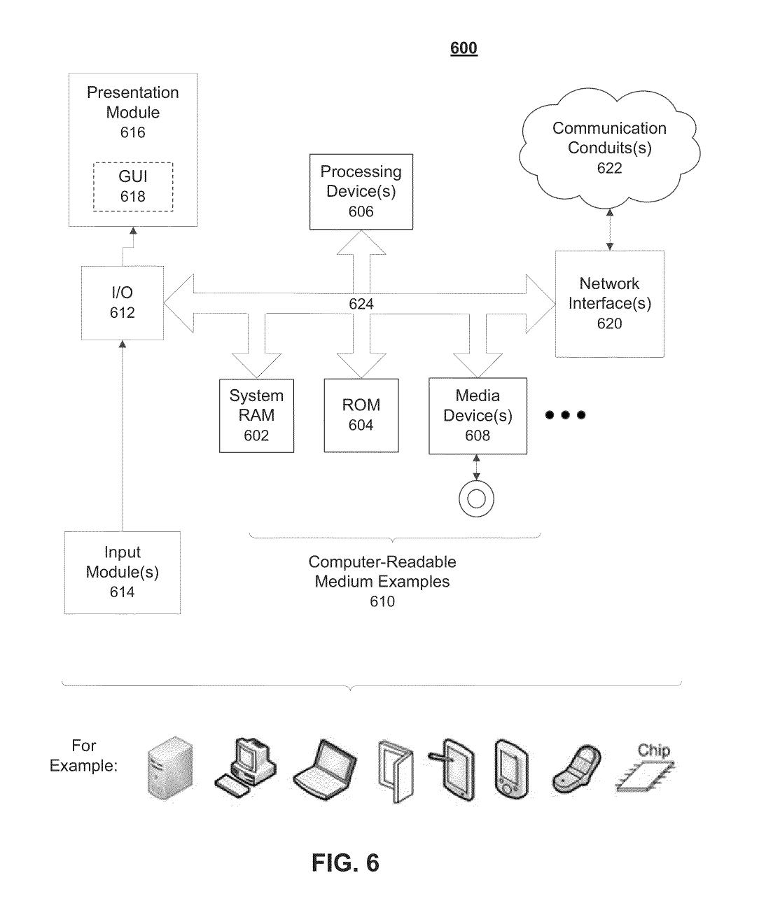

Referring now to FIG. 6, a block diagram of an exemplary computer system useful for implementing various aspects the processes disclosed herein, in accordance with one or more aspects of the present disclosure, is shown.

That is, FIG. 6 sets forth illustrative computing functionality 600 that may be used to implement web server 114, one or more application servers 116, computing devices utilized by principal 102, asset providers 104, agents 106, surety 108, and bond holder 110 access Internet 112, or any other component of system 100. In all cases, computing functionality 600 represents one or more physical and tangible processing mechanisms.

Computing functionality 600 may comprise volatile and non-volatile memory, such as RAM 602 and ROM 604, as well as one or more processing devices 606 (e.g., one or more central processing units (CPUs), one or more graphical processing units (GPUs), and the like). Computing functionality 600 also optionally comprises various media devices 608, such as a hard disk module, an optical disk module, and so forth. Computing functionality 600 may perform various operations identified above when the processing device(s) 606 executes instructions that are maintained by memory (e.g., RAM 602, ROM 604, and the like).

More generally, instructions and other information may be stored on any computer readable medium 610, including, but not limited to, static memory storage devices, magnetic storage devices, and optical storage devices. The term “computer readable medium” also encompasses plural storage devices. In all cases, computer readable medium 610 represents some form of physical and tangible entity. By way of example, and not limitation, computer readable medium 610 may comprise “computer storage media” and “communications media.”

“Computer storage media” comprises volatile and non-volatile, removable and non-removable media implemented in any method or technology for storage of information, such as computer readable instructions, data structures, program modules or other data. Computer storage media may be, for example, and not limitation, RAM 602, ROM 604, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 600 may also comprise an input/output module 612 for receiving various inputs (via input modules 614), and for providing various outputs (via one or more output modules). One particular output mechanism may be a presentation module 616 and an associated GUI 618. Computing functionality 600 may also include one or more network interfaces 620 for exchanging data with other devices via one or more communication conduits 622. In some aspects, one or more communication buses 624 communicatively couple the above-described components together.

Communication conduit(s) 622 may be implemented in any manner (e.g., by a local area network, a wide area network (e.g., the Internet 112), and the like, or any combination thereof). Communication conduit(s) 622 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The terms “service,” “module” and “component” as used herein generally represent software, firmware, hardware or combinations thereof. In the case of a software implementation, the service, module or component represents program code that performs specified tasks when executed on one or more processors. The program code may be stored in one or more computer readable memory devices, as described with reference to FIG. 6. The features of the present disclosure described herein are platform-independent, meaning that the techniques can be implemented on a variety of commercial computing platforms having a variety of processors (e.g., desktop, laptop, notebook, tablet computer, personal digital assistant (PDA), mobile telephone, smart telephone, gaming console, and the like).

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the systems, methods and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

1. A computer-implemented method for facilitating the creation and management of a bond, the method comprising the steps of:
(a) receiving asset information from a principal;
(b) providing the asset information received from the principal to an asset provider;
(c) receiving asset provider criteria from the asset provider indicating at least one pledged asset which may be created based on the asset information received from the principal;
(d) determining bond criteria for issuing a bond by a surety, the bond criteria being related to the asset provider criteria received from the asset provider and the at least one pledged asset which may be created; and
(e) providing the bond criteria for the bond, the bond criteria comprising:
a net present value of an asset pledgeable by the principal; and
a bond premium chosen to maintain the at least one pledged asset.

2. The method of claim 1, wherein asset information comprises:
demographic information of a plurality of individuals associated with the principal.

3. The method of claim 2, wherein the at least one pledge asset which may be created is a plurality of life insurance policies on at least some of the plurality of individuals associated with the principal.

4. The method of claim 3, wherein the surety is the beneficiary of the plurality of life insurance policies until the bond is redeemed.

5. The method of claim 4, wherein the principal is the beneficiary of the plurality of life insurance policies after the bond has been redeemed.

6. The method of claim 1, further comprising the steps of:
(f) receiving, from the principal, a bond amount request; and
(g) providing the bond amount request to the asset provider and the surety for utilizing in determining the asset provider criteria and the bond criteria.

7. The method of claim 6, wherein at least one of: the asset provider criteria and the bond criteria indicate a minimum at least one pledged asset criterion based on the bond amount request received from the principal.

8. The method of claim 7, wherein:
the at least one pledge asset which may be created is a plurality of life insurance policies on at least some of the plurality of individuals associated with the principal; and
the minimum at least one pledged asset criterion is a minimum death benefit having the surety as the beneficiary per each of the plurality of life insurance policies created.

9. The method of claim 7, wherein:
the at least one pledge asset which may be created is a plurality of life insurance policies on at least some of the plurality of individuals associated with the principal; and
the minimum at least one pledged asset criterion is a minimum number of the plurality of individuals associated with the principal for which the plurality of life insurance policies must be issued.

10. The method of claim 1, wherein the principal is one of:
a municipality; a state agency; a county; a state; a corporate entity; a division of a corporate entity; a union; a federal agency; a country; and a department of a municipality.

11. The method of claim 1, wherein the at least one pledged asset is at least one of:
a plurality of life insurance policies; an property management agreement; and a bailment agreement.

12. The method of claim 1, wherein the bond premium comprises:
a pledged asset maintenance premium; and
a surety management premium.

13. The method of claim 12, wherein the pledged asset maintenance premium is a life insurance premium payable to the asset provider.

14. The method of claim 1, further comprising the steps of:
(f) receiving, from the principal, a selection of the bond; and
(g) issuing the bond to a plurality of bond holders.

15. A computer-implemented method for facilitating the creation and management of a bond, the method comprising the steps of:
(a) receiving, from a principal, a bond amount request;
(b) receiving, from the principal, asset information;
(c) providing the asset information received from the principal to an asset provider;
(d) providing the bond amount request to the asset provider and to a surety for utilizing in determining an asset provider criteria and a bond criteria;
(c) receiving the asset provider criteria from the asset provider indicating at least one pledged asset which may be created based on the asset information received from the principal;
(d) determining bond criteria for issuing a bond by the surety, the bond criteria being related to the asset provider criteria and the bond amount request received from the asset provider and the at least one pledged asset which may be created;
(e) providing the bond criteria for the bond, the bond criteria comprising:
a net present value of an asset pledgeable by the principal; and
a bond premium chosen to maintain the at least one pledged asset;
(f) receiving, from the principal, a selection of the bond; and
(g) issuing the bond to a plurality of bond holders.

16. The method of claim 15, wherein the at least one pledge asset which may be created is a plurality of life insurance policies on at least some of the plurality of individuals associated with the principal.

17. One or more computer storage media having stored thereon multiple instructions that facilitate the creation and management of a bond by, when executed by one or more processors of a computing device, causing the one or more processors to perform the steps comprising:
(a) receiving asset information from a principal;
(b) providing the asset information received from the principal to an asset provider;
(c) receiving asset provider criteria from the asset provider indicating at least one pledged asset which may be created based on the asset information received from the principal;
(d) determining bond criteria for issuing a bond by a surety, the bond criteria being related to the asset provider criteria received from the asset provider and the at least one pledged asset which may be created; and
(e) providing the bond criteria for the bond, the bond criteria comprising:
a net present value of an asset pledgeable by the principal; and
a bond premium chosen to maintain the at least one pledged asset.

18. One or more computer storage media as recited in claim 17, wherein asset information comprises:
demographic information of a plurality of individuals associated with the principal.

19. One or more computer storage media as recited in claim 18, wherein the at least one pledge asset which may be created is a plurality of life insurance policies on at least some of the plurality of individuals associated with the principal.

20. One or more computer storage media as recited in claim 17, wherein the multiple instructions further cause one or more processors to perform the steps comprising:
(f) receiving, from the principal, a bond amount request; and
(g) providing the bond amount request to the asset provider and the surety for utilizing in determining the asset provider criteria and the bond criteria.

21. One or more computer storage media as recited in claim 20, wherein at least one of: the asset provider criteria and the bond criteria indicate a minimum at least one pledged asset criterion based on the bond amount request received from the principal.

22. One or more computer storage media as recited in claim 17, wherein the bond premium comprises:
a pledged asset maintenance premium; and
a surety management premium.

23. One or more computer storage media as recited in claim 17, wherein the multiple instructions further cause one or more processors to perform the steps comprising:
(f) receiving, from the principal, a selection of the bond; and
(g) issuing the bond to a plurality of bond holders.

24. A system for facilitating the creation and management of a bond, comprising:
(a) at least one web server capable of providing a graphical user interface, via a communications network, to a plurality of computing devices, the plurality of computing devices configured to communicate with at least one of: a principal; an asset provider; a surety; and a bond holder; and
(b) at least one application server, communicatively coupled to the at least one web server via the communications network, the at least one application server comprising:
(i) an asset information collection service capable of receiving asset information from a principal;
(ii) a pledged asset creation service capable of providing the asset information received from the principal to an asset provider and receiving asset provider criteria from the asset provider indicating at least one pledged asset which may be created based on the asset information received from the principal; and
(iii) a bond creation service capable of determining bond criteria for issuing a bond by a surety, the bond criteria being related to the asset provider criteria received from the asset provider and the at least one pledged asset which may be created and providing the bond criteria for the bond, the bond criteria comprising:
a net present value of an asset pledgeable by the principal; and
a bond premium chosen to maintain the at least one pledged asset.

25. The system of claim 24, the at least one application server further comprising:
(iv) a bond request communication service capable of receiving, from the principal, a bond amount request and providing the bond amount request to the asset provider and the surety for utilizing in determining the asset provider criteria and the bond criteria.

26. The system of claim 24, the at least one application server further comprising:
(iv) a bond issuance service capable of receiving, from the principal, a selection of the bond and issuing the bond to a plurality of bond holders.
